(19) United States
(12) Patent Application Publication
(10) Pub. No.: US 2006/0218289 A1
(43) Pub. Date: Sep. 28, 2006

(54) Systems and methods of registering and utilizing domain names

(75) Inventor: Elias Assad, Ottawa (CA)

Correspondence Address: Elias Assad, 50 Kaymar Drive, Ottawa, K1J7C7, CA

(73) Assignee: Elias Assad, Ottawa (CA)

(21) Appl. No.: 10/907,273

(22) Filed: Mar. 27, 2005

(51) Int. Cl. G06F 15/16

(52) U.S. Cl. 709/229

(57) ABSTRACT

The present invention provides methods and systems for registering unlimited non-ICANN top-level domain (TLD) names that are created on demand, and for utilizing them in a network environment in parallel with those specified by the Internet Corporation for Assigned Names and Numbers (ICANN) or other authority authorized to approve standardized top-level domain names. One embodiment of the present invention provides systems and methods for registering a non-ICANN TLD name by mapping it to an IP address using a predefined mapping function, assigning the resulting IP address to a server system that acts as the name server for TLD name, and subsequently using the said predefined function when a user enters an Internet address containing said TLD name on a client computer in order to compute the IP address of the said name server and access it. Further, one embodiment of the present invention is operable with proxy servers.

### BACKGROUND OF THE INVENTION

1. Field of the Invention

The present invention is related to domain names, and in particular to methods and systems for creating and using non-ICANN top-level domain names.

2. Description of the Related Art

In distributed computer networks, being able to locate individual computers, servers, or various other machines on the network is critical. On the Internet, one of the most valuable identification resources is the domain name. Internet domain names provide a convenient way to reference Internet Protocol (IP) numerical addresses. Presently, IP addresses are 32-bit integers. They comprise four numbers separated by periods. Every “host” machine (e.g., computer, etc.) connected to the Internet must be identifiable by a specific numerical IP address. However, people prefer to reference host machines by pronounceable, easily remembered names, referred to as “domain names.” The Internet implements a Domain Name System (DNS) to facilitate matching specific domain names to specific hosts.

The DNS is a distributed database system that allows computer applications to map between domain names and IP addresses. The DNS also provides electronic mail routing information and many other services. Individual components of the DNS distributed database can be cached locally, or stored on any of numerous distributed machines. The DNS database data correlates each domain name to a specific numeric IP address. If a computer's local cache does not have the information to resolve a domain name into an IP address, it sends a request to other computers that may contain the resolution information. The DNS affords a domain name some measure of independence from the physical location of a host. The host can be moved to a new location on the network, but it can still be accessed using the same domain name. As long as a user can remember the domain name, the host can always be located, even if the IP address changes over time.

Physically, the DNS comprises many servers and other computers or machines that run software and store data permitting computers to query the DNS database. One such machine is the “root server.” A root server is a server computer that maintains the software and data necessary to locate “name servers” that contain authoritative data for a specific domain, such as the “.com” top level domain. There are presently thirteen root servers throughout the world. Name servers are computers that have the software and data to resolve the domain name into an IP address. The data accessible through the name server is often referred to as a “zone file.” A “zone” is a subset of the total domain name space. The domain names in that subset are stored in the zone file for that name server. There is a zone file for each domain space (i.e., zone).

The DNS is organized in a hierarchical, tree structure. A domain name is the label representing a specific domain within the total possible domain space available in the DNS. The highest level in the DNS hierarchy is the “root,” which is technically unnamed but often referred to as the “.” or “dot.” The level immediately below the root in the DNS hierarchy is the top-level domain, or “TLD.” It is called the “top-level domain” because it is the highest level in the hierarchy after the root. The TLD appears furthest to the right in an English-language domain name. For example, “gov” in the “uspto.gov” domain name.

By registering a domain name in a particular TLD, the TLD is sub-divided into lower levels in the DNS hierarchy. A second-level domain (SLD) is the level in the DNS hierarchy immediately below the TLD. An example of a second-level domain would be “ibm” in the “ibm.com” domain name. The level in the DNS hierarchy immediately below the second-level domain is the third-level domain. An example of the third-level domain would be “portland” in the “portland.or.us” domain name. Further subdivisions can be created in a similar manner. Domain names at each level of the hierarchy must be unique. Thus, while there can be only one “ibm” registered in the “.com” TLD, there can be a “ibm.net” domain name in addition to the “ibm.com” domain name.

Historically, domain name registration has been conducted through a Shared Registration System (SRS) involving registries, registrars, and registrants. The SRS was created by Network Solutions, Inc. in 1999 to provide a registry backend through which multiple, globally diverse registrars could register domain names. The term “registry” refers to the entity responsible for managing allocation of domain names within a particular name space, such as a TLD. One example of a registry is the VeriSign registry for the .com, .org, and .edu TLDs. The term “registrar” refers to any one of several entities with authority to issue commands or requests to add, edit, or delete registrations to or from the registry for a name space. Entities that wish to register a domain name do so through a registrar. The term “registrant” refers to the entity registering the domain name. In some name spaces, the registry and registrar functions can be performed by the same entity. The overall registration system, including multiple registries, is overseen by the Internet Corporation for Assigned Names and Numbers (ICANN). ICANN is a non-profit corporation that was formed to assume responsibility for the IP address space allocation, protocol parameter assignment, domain name system management, and root server system management functions previously performed under U.S. Government contract by the Internet Assigned Numbers Authority (IANA) and other entities.

Once a domain name is registered, an online user can utilize a web browser to access and view websites by entering an Internet address in the form of a domain name, such as www.domain-1.com, for example, or a Uniform Resource Locator (URL), such as http://www.domain-1.com/index.htm. Thus, for instance, the Internet address for the White House's website is www.whitehouse.gov.

The browser extracts the Internet address, www.domain-1.com, from the URL, mentioned above, and transmits a look-up request, including the extracted address, to a Domain Name System server (DNS server). In response to the look-up request, the DNS server returns the IP address corresponding to the domain name to the browser. The browser then uses the IP address to access the corresponding computer. It may take a number of servers to locate the corresponding IP address. For example, a first name server for the “com” top-level domain stores the IP address for a second name server that stores the host names. A separate query is then made by the first name server to the second name server for the actual IP address for domain-I's web server. The request for “www.domain-1.com”, by way of example, might be translated to 183.52.148.72. The request for that specific webpage can then be routed to domain-I's web server.

Disadvantageously, there is a very limited number of ICANN top level domains. As a result, this limits the number of ICANN domain names available to users. Further, this limitation makes it more difficult to organize access to the Internet.

Domain names, or more specifically domain name registrations, have become significant business (and personal) assets. Registration rights are now bought, sold, traded, bartered, auctioned and stockpiled in “inventories.” At the time of this writing, Verisign, Inc.—the company that maintains the .com, .net, and .org TLD registries—reports over 32 million registrations in its database. Industry statistics indicate, however, that only about 10% of the domain names registered are currently in actual use, including more than just a simple holding or redirection page. Many registrations are the work of speculators.

There are various types of TLDs. The term “gTLD” is often interchangeably used to refer to a “global top-level domain” or a “generic top-level domain.” A global TLD is one that can be registered by an entity regardless of the entity's geographic location or political boundary. New gTLDs are being added as the older ones—.com .net org—become saturated. The realm of possible names under a given gTLD is not the problem, it is immense. (Names up to 67 characters long, plus the extension, apparently can be registered today.) The trouble is that popular, easy to remember or easy to recognize names are relatively limited in number. Many of the most desirable domain names, those corresponding to well-known trademarks or generically describing commercial goods or services, are long since taken in the basic gTLD spaces.

The limited number of TLDs in the current DNS system negatively impacts the growth of the Internet because it does not fully meet the domain name needs of individuals, businesses and other organizations. The scarcity of TLDs is directly responsible for the rise of speculation and “cyber-squatting”. In addition, the advent of version 6 of the Internet Protocol, IPv6, would enable—and coincide with several developments. Since the number of possible IPv6 addresses is practically inexhaustible, there will be no need to assign temporary IP addresses to computers and other devices. It is projected that each person will eventually have as many as 100 IP addresses for personal, home, and business use. The current DNS, with a potentially limited root server system and a limited number of TLD names, may not meet the needs of hundreds of millions of users for convenient communication, in which a uniform and well understood naming mechanism plays a pivotal role. For example, an individual who wants to use their name for a domain name currently have to use the “.name” TLD, as in “Firstname.Lastname.name”, which could be considered less desireable to just using “Firstname.Lastname” as a domain name. With the ability, provided by this invention, to make practicable the assignment of a SLD name to an individual, one benefit would be the use the domain name “Firstname.Lastname” as an email address. More generally, it would make it practical to use a single domain name to access different network resources when using different protocols that would provide the differentiating contexts. More benefits would entail when one considers the potential to address multiple personal devices using the DNS system. Machine to machine communication, where programs on different machines communicate without direct interaction with human operators, would also benefit from a DNS system that is scalable to support millions of TLD names, and is unlimited by the limitations of the current system.

### SUMMARY OF THE INVENTION

The present invention is directed to methods and systems used to provide and use unlimited top-level domain names that are created on demand, in parallel with those specified by the Internet Corporation for Assigned Names and Numbers (ICANN) or other authority authorized to approve standardized top-level domain names.

In accordance with one embodiment of the present invention, a domain registration system uses a predefined function that maps the TLD name to an IP address, herein termed TLDIP address, which belongs to a set of IP addresses reserved a priori for a group of name servers. If the TLD name has not been registered before, the registration system assigns the TLDIP address to a network interface on a name server computer, which would then become the designated TLD name server for said TLD.

In accordance with another embodiment of the present invention, a DNS extension software running on a client computer system uses the said predefined function when a user enters an Internet address containing a non-ICANN TLD name on a client computer in order to compute the IP address of the corresponding TLD name server and access it, and thereby enable browsers and other connectivity devices or systems to access and/or utilize non-ICANN top-level domains. The registration and use of the Internet addresses utilizing the non-ICANN top-level domain (TLD) names can be performed using different embodiments of processes and systems in accordance with the present invention.

In one embodiment, the user downloads the DNS extension software program to a client computer system that includes WinSock2 or equivalent service providing an interface to the Name Space Provider(s) and Layered Service Provider(s) to enable utilization of the non-ICANN domain addresses, as discussed in greater detail below.

The DNS extension software may be downloaded or installed from a floppy disk, CD-ROM, via a network, such as the Internet, or may be pre-installed on the client computer. The downloaded DNS extension software processes non-ICANN address requests (those addresses that do not end in .com, net, .org, mil, an ICANN-defined two letter country code, or other ICANN specified TLDs) received from a browser or other application by computing the IP address of the TLD name server from the characters of the TLD name.

For example, a user downloads the DNS extension software and then, using the browser, requests a non-ICANN address, such as John.Doe. As on conventional systems, the process begins with the browser requesting the operating system services to identify the numeric location of the requested website. In searching for the server location, the operating system utilizes the DNS extension software, which resolves the domain name and returns the IP address that identifies the requested website.

Another embodiment provides a process for accessing the non-ICANN Internet addresses through the user's ISP. This approach is performed in a manner transparent to the consumer, as it does not require the DNS extension software to be installed on the user's system. Advantageously, utilizing such non-ICANN TLDs attracts more consumers. By way of example, the user enters or provides a browser with a non-ICANN Internet address (e.g., John.Doe) of a website or other network resource. The browser, in communication with the operating system, sends an IP address lookup request to the ISP's domain name system server. If the domain name system server implements the methods disclosed herein, applying a predefined function to compute the IP address of the TLD name server, it then locates the IP address representing the server of the requested page.

### BRIEF DESCRIPTION OF THE DRAWINGS

FIG. 1 illustrates an example process for creating a non-ICANN TLD name and an SLD name in accordance with one embodiment of the present invention;

FIG. 2 illustrates an example process for creating a non-ICANN TLD name and an SLD name in greater detail using sample data;

FIG. 3 illustrates an example process for using an Internet address comprising a non-ICANN TLD name to access a network resource in accordance with one embodiment of the present invention;

FIG. 4 illustrates an example process for using an Internet address containing a non-ICANN TLD in greater detail;

FIG. 5 illustrates an example process for using an Internet address containing a non-ICANN TLD using a proxy server in accordance with one embodiment of the present invention.

### DETAILED DESCRIPTION OF THE PREFERRED EMBODIMENT

The present invention is directed to methods and systems used to provide and use unlimited top-level domain names that are created on demand, in parallel with those specified by the Internet Corporation for Assigned Names and Numbers (ICANN) or other entity having the governmentally or community granted authority to approve or create standardized top-level domain names.

In particular one embodiment of the present invention provides systems and methods for registering a non-ICANN TLD name by mapping it to an IP address using a predefined mapping function, assigning the resulting IP address to a server system that acts as the name server for TLD name, and subsequently using the said predefined function when a user enters an Internet address containing said TLD name on a client computer in order to compute the IP address of the said name server and access it.

Throughout the following description, reference will be made to various implementation-specific details, including, for example, coding conventions, operating systems, document and protocol standards, Internet connectivity systems, and database records. These details are provided in order to fully set forth a preferred embodiment of the invention, and not to limit the scope of the invention. On the contrary, the invention is intended to cover alternatives, modifications and equivalents, which may be included within the spirit and scope of the invention as defined by the appended claims. For example, the following discussion refers to utilizing web browsers to access the Internet using the present invention; and it does not specify the version of Internet Protocol (IP). Of course, other connectivity tools, such as FTP, email, voice communication programs, or Telnet can be used as well; and the methods and systems described herein are equally applicable to IPv4 and IPv6.

An embodiment utilizing a server-based implementation for registering non-ICANN TLD names on demand and a client-based implementation for using non-ICANN TLD names on client computers will now be described. To register the non-ICANN TLD name, a webpage containing a registration form is transmitted from a server to the client computer system of a person desiring to register a domain name. The server, herein termed Registrar Server, is optionally associated with an entity that registers, sells, and tracks non-ICANN TLD and SLD names, termed herein, a TLD company, or an entity that registers, sells, and tracks SLD based on non-ICANN TLD names, termed herein, a Registrar. The TLD company further operates a group of servers comprising at least one Registry Server, at least one TLD Farm Server, and at least one TLD Name Server, the roles of which are clarified herein.

The person desiring to register a domain name uses a registration form to enter a desired non-ICANN TLD name and an SLD name, as in “SLD.TLD”, and the desired the SLD's name server address, among other information. The person then submits the registration form to the server by, for example, clicking a submit button on the Webpage containing the registration form. The Registrar Server extracts at least the entered domain name (“SLD.TLD”) and the SLD's name server address and submits them to the Registry server using, for example, an Internet standard Registry-Registrar protocol. The Registry server then verifies the availability of the domain name in its database. If the “SLD.TLD” domain name is not available or otherwise cannot be registered, e.g., it has been registered to another person, the Registry server returns a message to that effect to the Registrar server, which in turn sends a corresponding message or Webpage to the person's computer.

If the “SLD.TLD” name is available for registration, the Registry server sends a registration request to the TLD Farm Server. The TLD Farm Server uses a predefined function that maps the TLD name to an IP address, herein termed TLDIP address, which belongs to a set of IP addresses reserved a priori by the TLD company. If the TLD name has not been registered before, the TLD Farm Server assigns the TLDIP to a network interface on a server computer, which would then become the designated TLD name server for the said TLD name, and creates the TLD zone file on the TLD name server.

Once the TLD has been registered and assigned a TLD name server, and the TLDIP address assigned to its TLD name server, the TLD Farm Server will then use this TLDIP address to connect to the TLD name server and cause this and subsequent SLD registration functions to be carried out in accordance with standard DNS procedures.

The predefined mapping function, herein termed TLDIP function, maps the TLD name's character string to a numeric value representing an IP address that falls within a range of IP addresses used by the TLD company for the operation of its group of TLD name servers, which addresses might be IPv4 or IPv6 addresses. For example, the TLDIP function may use the first few characters of the TLD name, and maps each combination to a unique IP number having the subnet prefix of the subnet used by TLD company for its TLD name servers. The TLDIP function may be implemented by starting with an initial value pair (Character string, IP address) and incrementing both while observing the rules of their respective domains until reaching the value for of the character string of the TLD name. For example, if the TLD name “aa” is made to correspond to “24.153.0.0”, then “ab” would correspond to “24.153.0.1”. In one embodiment, the TLDIP address may also be computed from the character string by way of an algorithm that uses the numeric code (e.g., ASCII) of the characters in the TLD name to compute the corresponding IP address, or by assigning IP addresses to ranges of character strings. In one embodiment, the TLDIP function may implement rules to generate IP addresses belonging to different subnets, as to allow multiple TLD companies to operate TLD name servers, or to allow for the possibility of changing subnets of the same TLD company. It will be obvious to those having skill in the art that the TLDIP function's implementation depends on several factors, including the actual IP addresses that would be available to the TLD name servers, the naming rules that would be supported by the TLD company for non-ICANN TLD names, and even business considerations. In one embodiment, the TLDIP function is updated periodically to change, if required, the subnet prefix or the algorithm it uses to compute IP addresses. The use of the same TLDIP function in registering TLD names and in using them, as disclosed herein, eliminates the need for a domain root server and allows for unlimited TLD names to be created on demand. For illustration purposes only, if the TLDIP function were to use the first 4 characters of the TLD name, it would generate a possible 1,874,161 TLD names (37 possible characters under RFC1035, to the power 4), and if it were to map an IP address to each of these names, it would utilize a subnet prefix and mask of 255.224.0.0/32, providing 32 Class B IPv4 addresses, or 2,097,152 unique IP addresses, and supporting potentially an equal number of TLD name servers. It should be noted in the above example that two TLD names sharing the same first 4 characters would also share the same TLD name server.

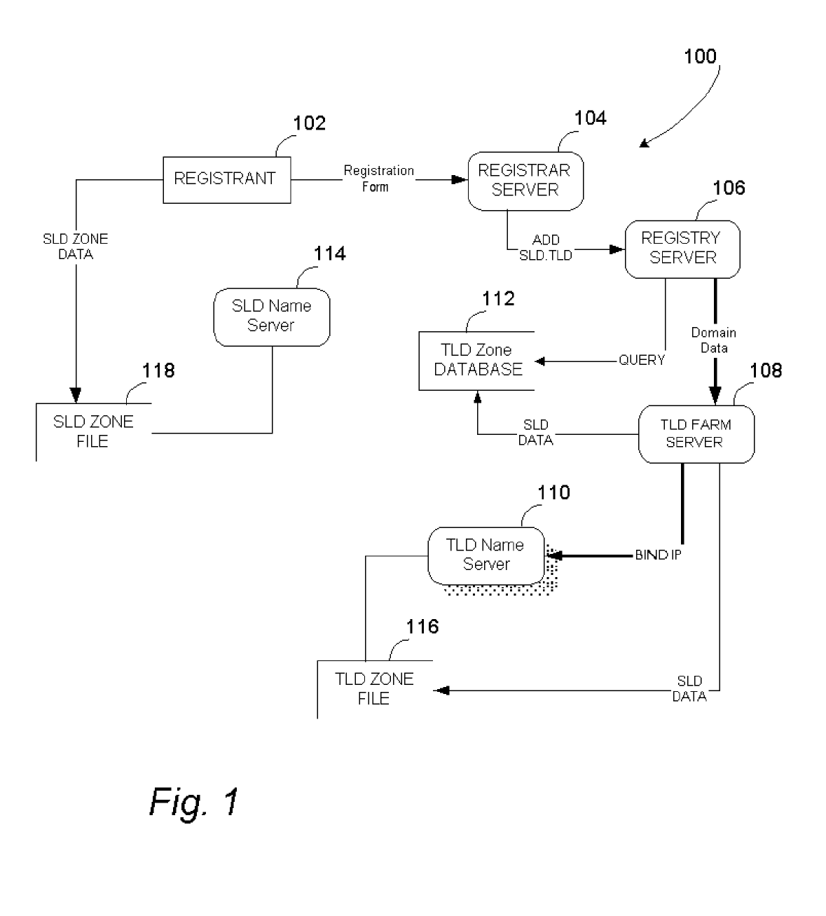

FIG. 1 illustrates an example process 100 where a domain name, including a non-ICANN TLD name, is created in accordance with the present invention. In one embodiment, the domain names are optionally required to be RFC1035 compliant, in that they are restricted to the RFC1035 defined character set, including characters selected from the set of the letters A-Z in upper and lower case, the numbers 0-9, and a hyphen “-”.

A Registrant 102 enters in a registration form or otherwise provides registration data to the Registrar Server 104. Registration data includes a non-ICANN TLD name, and an SLD name and its name server data. The Registrar Server 104 extracts the non-ICANN TLD, and SLD name and its name server data and submits an “ADD SLD.TLD” request to the Registry Server 106 using, for example, Registry-Registrar Protocol (RFCs 2832 & 3632) or the Extensible Provisioning Protocol (an IETF Draft). The Registry Server 106 queries the TLD Zone Database 112, which is used to store the zone data belonging to all TLDs in the system. The Registry Server 106 then implements the following:

if the domain name “SLD.TLD” is already present in the database 112, or is flagged in the data base as unavailable, it replies to the Registrar Server with the appropriate failure response code;

otherwise, if TLD is already present in the database 112, it passes the registration data to the TLD Farm Server 108 with a request to add the SLD data to the TLD Zone file;

otherwise (i.e., new TLD), it passes the registration data to the TLD Farm Server 108 with a request to create the TLD zone file and add the SLD data to it.

In the latter two cases, the TLD Farm Server uses the TLDIP function to compute an IP address from the TLD name. If the request from the Registry Server is to create a new TLD name, the TLD Farm Server 108 selects a server from the group of TLD name servers 110 (e.g., based on historical load or geographical location criteria) and binds the computed TLDIP address to an interface on the selected server, acting in a manner similar to a DHCP server—where a process on the selected server, in communication with the TLD Farm Server, receives the TLDIP address and does the binding. In one embodiment, the TLDIP function is designed to produce a second IP address corresponding to the character string of the TLD name, allowing the TLD Farm Server to bind the second IP address to an interface on a second server possibly belonging to another subnet. The TLD Farm Server 108 then adds the SLD data to the TLD Zone file 116. Otherwise, if the request from the Registry Server 106 is only to add the SLD to the TLD Zone file 116, the TLD Farm Server 108 uses the computed TLDIP address to connect to the TLD name server 110 that already has TLDIP assigned to it, and adds the SLD data to the TLD Zone file 116.

If the writing of the SLD data to the TLD Zone file is successful, the TLD Farm Server 108 updates the TLD Zone Database 116 accordingly, and returns a success response code to the Registry Server 106, which gets relayed eventually to the Registrant 102.

The Registrant 102 now writes the SLD Zone Data as usual to an SLD Zone File 118, making it available to the SLD name server 114.

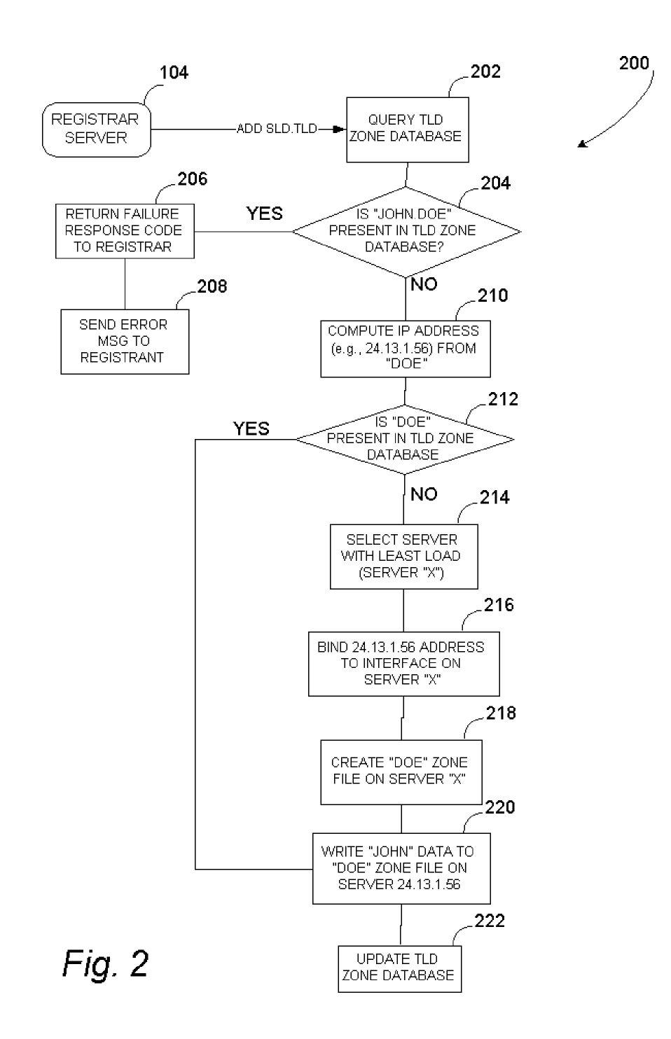

Referring to FIG. 2, an example process 200 for registering a TLD and an associated SLD is presented in greater detail using the sample domain name “JOHN.DOE”. The Registrar 104, having received a Registration Form from a registrant, submits the domain data and a request to add the domain name “JOHN.DOE” to the Registry Server, which queries the TLD Zone Database 112 at state 202. If there is a record for “JOHN.DOE” at state 204, the Registry Server returns a failure response code at state 206 to the Registrar Server, which sends an error message at state 208 to the registrant. Otherwise, at state 210, the TLD Farm Server computes the least significant pieces of an IP address from the string “DOE”, and concatenates them to a pre-assigned subnet prefix resulting, for example, in an IP address of “24.13.1.56”. The TLD Farm Server checks if “DOE” is present in the TLD Zone Database in the content of the request it received from the Registry Server at state 212. If “DOE” is not present, it selects, at state 214, a server “X” from the group of servers designated as TLD name servers, which selection may be based on load data it receives regularly from the TLD name servers. The TLD Farm Server, at state 216, causes server “X” to bind the address of “24.13.1.56” to an interface on server “X”. This binding may be performed by a message to a process running on server “X”. The TLD Farm Server then writes the “DOE” Zone file to server “X” at state 218.

At state 220, whether or not “DOE” was present in the TLD Zone Database, the TLD Farm Server writes “JOHN” domain data, including its name servers' data, to the “DOE” Zone file, and updates the TLD Zone Database at state 222 to reflect the registration of “JOHN.DOE”.

A client-based software implementation for using non-ICANN TLD names on client computers will now be described. This software, herein termed DNS extension software, can be downloaded via a webpage that may be hosted on any Web server. Embedded on the webpage is downloadable DNS extension software, for example, a Java applet or ActiveX control, which may be digitally signed to ensure its authenticity and provide some measure of assurance that the author certifies that the DNS extension software is safe to run and that it has not been altered. Upon viewing the webpage using a client-based browser, the user may be asked by their web browser whether the embedded DNS extension software should be permitted to run, assuming the browser verifies that the digital signature is valid and that the content has not been altered since the content was digitally signed.

Once the user agrees to allow the embedded DNS extension software to run, the embedded program verifies that the user's system contains Microsoft Winsock2 or an equivalent programming interface. Winsock, short for Windows sockets, is an Application Programming Interface (API) for developing Microsoft Windows compatible programs that can communicate with other machines via the TCP/IP protocol, or the like. Of course other operating systems and APIs can be used as well. If the user's system does contain Winsock2 or equivalent, the embedded program installs a Winsock2 Name Space Provider (NSP), also termed, in this example, the TLD NSP, to provide functionality for processing TLDs that are registered in accordance with this invention.

WinSock2 utilizes the Windows Open Systems Architecture (WOSA) model, which separates the API from the protocol service provider. The WinSock DLL provides the standard API, and each vendor's service provider layer is installed below the standard API. The API layer communicates to a service provider via a standardized Service Provider Interface (SPI), and can multiplex between multiple service providers simultaneously. Winsock2 contains a first NSP, termed herein a Default NSP, and the TLD NSP is added as a second NSP. The default NSP is typically installed when Transmission Control Protocol/Internet Protocol (TCP/IP) support is installed.

A Winsock2 NSP is a dynamic link library (DLL) that enables the conversion of alphanumeric names, such as www.domain-name1.com, to numeric addresses, such as 192.9.200.1, used to contact specific computers and their services. When an Internet address is entered in a web browser, or referred to by a link on an HTML document, the web browser uses Winsock2 or equivalent to perform the conversion of alphanumeric names to numeric addresses. Winsock2, in turn, utilizes installed Name Space Providers to perform the conversion using the Winsock2 Service Provider Interface (SPI).

The TLD NSP, once installed as described above, is listed in the Winsock2 service's catalog of Name Space Providers in addition to the default provider. Once the TLD NSP is listed in the Winsock2 NSP catalog, other applications gain access to the TLD NSP's services via Winsock2, as in the web browser example described above.

In general, NSPs perform domain name conversions by using the DNS server lookup protocol to establish a connection with the user's domain name system servers and locate IP addresses which are typically provided by a user's Internet Service Provider (ISP). Using the DNS server protocol, a NSP sends the alphanumeric address to the DNS server and receives the IP address(es), or when appropriate, receives a response that the alphanumeric address is not valid. For example, if a user requests an Internet address with a non-ICANN TLD, such as www.john.doe, the default provider would not validate the address, unless the ISP has provisioned their DNS servers to recognize the non-ICANN TLDs, as described below. However, if the TLD name has been registered with the TLD company then, with the TLD NSP installed, the address will be resolved even if the ISP's DNS server does not implement the method disclosed herein.

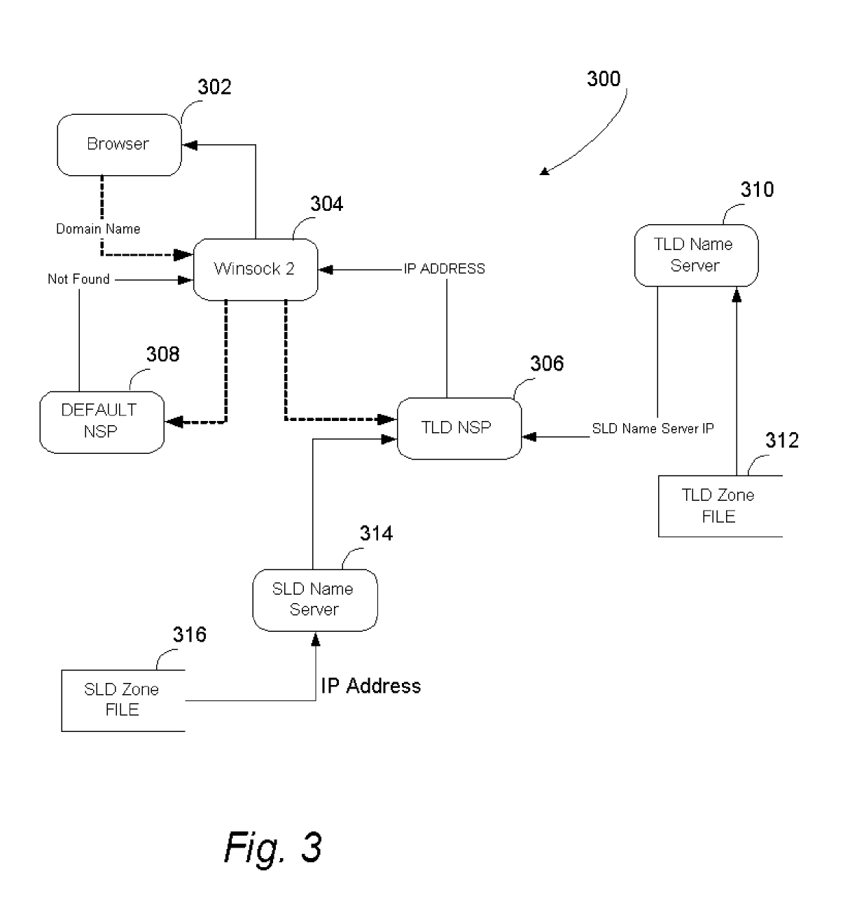

Referring to FIG. 3, the user initially enters or otherwise provides an Internet address containing a non-ICANN TLD name using a browser 302 or other Internet application. The browser passes the domain name to Winsock2 304, which in turns contacts the Default NSP 308 and the TLD NSP 306 and requests the resolution of the domain name. If the ISP's DNS resolves TLD domain names using the TLDIP function, then the ISP DNS server returns an IP address to the Default NSP, allowing the browser to connect to the server represented by the IP address and to load the requested resource. Such DNS server would also implement a response to a query sent periodically by the TLD NSP identifying its implementation, which would cause the TLD NSP to respond with a “Not Found” result to Winsock2, letting the Default NSP and the ISP's DNS perform the resolution function. Thus, one embodiment of this invention provides a process for accessing the non-ICANN Internet addresses through the user's ISP, which does not require the DNS extension software to be installed on the user's system. Process 300 however assumes that the ISP's DNS does not implement the DNS extension software, which causes the Default NSP to return “Not Found” to Winsock2.

The TLD NSP 306 running on the client computer system now utilizes an instance of the same TLDIP function that is used by the TLD Farm Server mentioned above. The TLD NSP extracts the non-ICANN TLD name from the domain name, and uses the TLDIP function to compute a TLDIP address; if the TLD name had been registered in accordance with this invention, the TLDIP address thus computed would have been bound to an interface on a TLD Name Server 310. For example, www.john.doe is entered in the browser address field, the TLD NSP extracts “doe” from it and uses the TLDIP function to find the IP address (24.13.1.56) of the “doe” name server. This latter server, when requested by TLD NSP, retrieves the IP address of the SLD Name Server 314 from the TLD Zone File 312 and returns it to the TLD NSP. Likewise, the SLD Name Server 314, when requested by the TLD NSP, serves the IP address of the requested resource from the SLD Zone File 316 to the TLD NSP, which returns it to Winsock2, allowing the browser 302 to locate the website and display the requested resource.

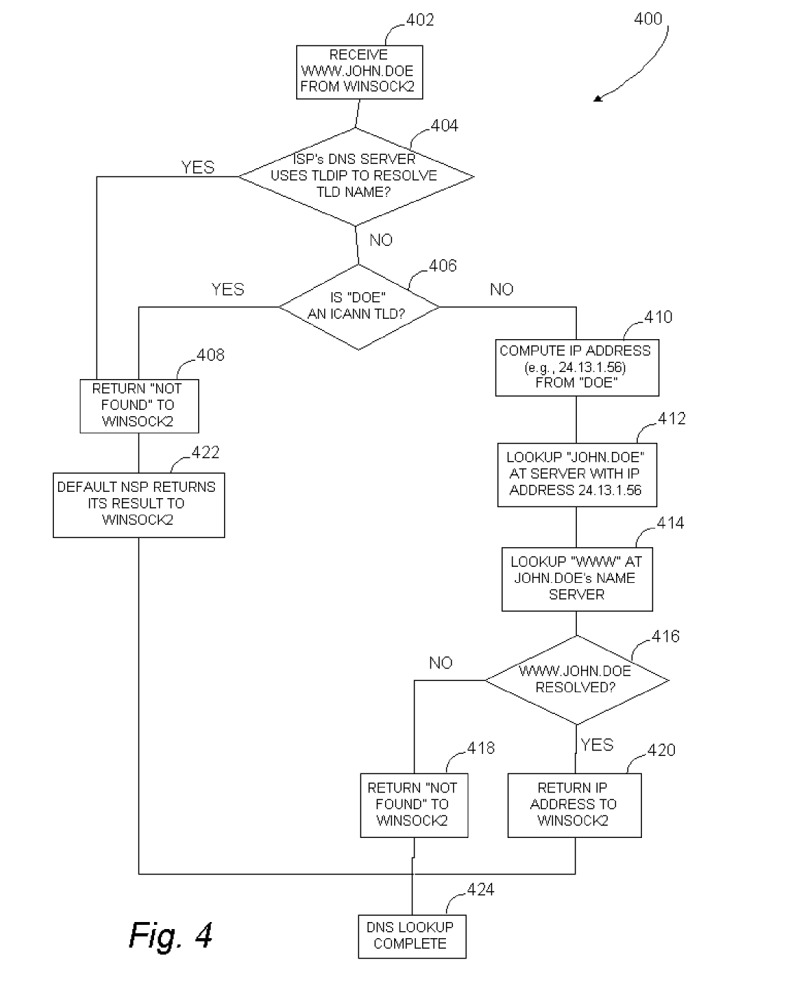

FIG. 4 illustrates an example process 400 utilizing non-ICANN TLDs in greater detail. Example process 400 can also be used with other Internet addresses using different protocols, such as FTP, Gopher, Telnet, or the like. In addition, while the following description assumes a browser is being used to request network resources, the present invention can be used with other requesting applications. At state 402, the TLD NSP receives a domain name, “www.john.doe” from Winsock2, or equivalent, via SPI calls. At state 404, the TLD NSP verifies whether the ISP's DNS server uses TLDIP to resolve TLD names, in which case the TLD NSP at state 408 returns a “Not Found” response to Winsock2. This allows the ISP's DNS server to supply name resolution to the Default NSP, which returns the result to Winsock2 at 422. If the ISP's DNS does not use TLDIP, then at state 406, the TLD NSP examines the TLD name portion of the domain name to determine if it matches one of several predefined top-level domain names which are valid in the ICANN DNS namespace. In one embodiment of the present invention, the TLD NSP is periodically updated by contacting a host server to update a list of the ICANN recognized or defined standard TLDs (e.g., “.com”, “.org”, “.mil”, “.gov”, “.info”, “.biz”, “.name”, or the two letter ending of a country such as “.uk”, “.de”, etc).

If the TLD name matches one of the ICANN TLDs, the TLD NSP at state 408 returns a “Not Found” response to Winsock2, again allowing the ISP's DNS server to supply name resolution to the Default NSP, which returns the result to Winsock2 at state 422. For example, a requested address, such as www.ibm.com would cause a “Not Found” response to be sent by the TLD NSP, while it would be successfully resolved by the Default NSP using the standard DNS lookup process. However, in the case that the TLD name is a non-ICANN TLD, such as “DOE” in this example, the TLD NSP at state 410 computes the IP address of the TLD name server by applying the TLDIP function to the TLD name. For example, the IP address “24.13.1.56” would be computed from the TLD name “DOE”. The rest is standard DNS process: the TLD NSP at state 412 would request resolution of “JOHN.DOE” from the TLD name server having the IP address “24.16.1.56”, which would result in the IP address of the name server for the SLD JOHN.DOE, and then at state 414 request the resolution of WWW from the JOHN.DOE name server. If the entire domain name “www.john.doe” was resolved successfully, its IP address is returned to Winsock2 at state 420; otherwise a “Not Found” response is returned at state 418.

Once the results described above are gathered by Winsock2 at state 424, the original requester, in this case the Web browser, receives the results via the Winsock2 or equivalent programming interface, and accordingly either displays a “not found” page or uses the supplied IP address to retrieve the resource from the server “www.john.doe”.

Thus, process 400 allows non-standard addresses to be resolved to the corresponding IP addresses of network resources, such as computers, on the Internet. This enables a user to view webpages or other content (such as FTP data), regardless of whether the domain name is an ICANN registered one.

Another embodiment of the present invention provides for utilizing a Layered Service Provider (LSP) supplied by the TLD company to enable resolution of Internet addresses including non-ICANN top-level domain names. The LSP is utilized when a proxy server is used.

Winsock2 allows the creation of LSPs which can be stacked into chains. The LSP is installed on top of a default Transport Service Provider (TSP). One function of an LSP is to filter data, for a variety of reasons, communicated between two applications. The LSP can be used to filter, by way of example, TCP and/or UDP (User Datagram Protocol) traffic. The LSP can then be used to monitor Internet addresses containing non-ICANN TLDs in accordance with one embodiment of the present invention. In particular, the LSP can be used to provide filtering of traffic through the sockets. By monitoring socket traffic, use of an application-level protocol can be detected. The LSP detects a non-ICANN address in the HTTP or proxy application level protocol, extracts the non-ICANN address and resolves it by computing the TLDIP address as outlined above and contacting the TLD Name Server and subsequently the SLD Name Server. The LSP then replaces the non-ICANN address in the URL contained in the appropriate headers in the protocol with the corresponding IP address and forwards it to the proxy. In one embodiment of the present invention, the LSP is periodically updated by contacting a host server to update a list of the defined ICANN TLD names.

If a proxy server is used, the LSP intercepts the Internet address if the Internet address includes a non-ICANN TLD, as described above. A proxy server is an Internet server that generally acts as a mediator between the client computer system and other servers hosting webpages. The proxy server can, for example, sit on a firewall and protect the client systems from unauthorized access via the Internet. In addition, the proxy can intercept and selectively block webpage requests coming from users within the firewall. A firewall is a software program or hardware device that filters information coming through the Internet, for example, offensive websites. The proxy server can also function as a caching server. Utilizing the proxy server's cached webpages, the proxy server will display previously accessed webpages to users without requiring outside access to the Internet, advantageously improving a network's performance. Of course, a proxy server can be used without a firewall. Because of such benefits, many users access the Internet via a proxy server.

One embodiment of the DNS extension software is, therefore, compatible with users who access the Internet via a proxy server. Normally, using a proxy setup, when a user sends a request for an Internet address, e.g. http://john.doe, the browser sends the string “http://john.doe/” directly to the IP address of the proxy. The proxy then performs the DNS server lookup for the request, retrieves the requested resource and returns the results to the user. The potential problem is the proxy server's DNS server may not have implemented the method of this invention to resolve non-ICANN domain names and would therefore fail to resolve the request for “john.doe”. To overcome this difficulty, an LSP provided by the TLD company, herein termed TLD LSP, is used to enable resolution of non-ICANN top-level domain names when a proxy server is used.

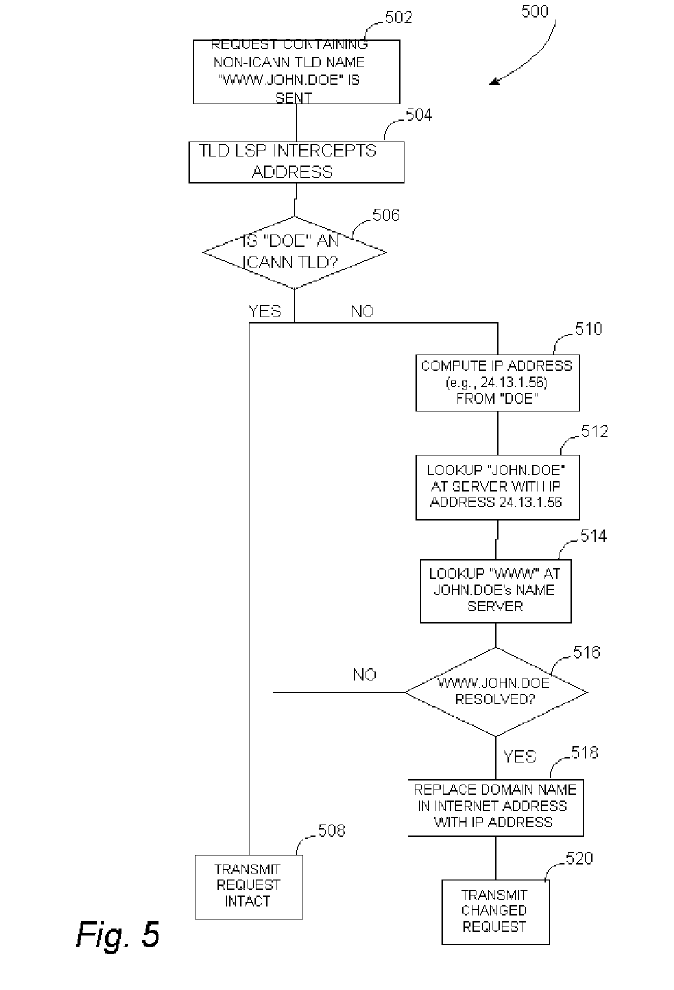

FIG. 5 illustrates an example process 500 wherein a TLD LSP is utilized to detect and resolve an Internet address containing a non-ICANN TLD before sending it to a proxy server. At state 502, a user enters or selects a non-ICANN Internet address. At state 504, the TLD LSP intercepts the Internet address. If the Internet address contains an ICANN TLD at state 506, then the TLD LSP transmits the request to the proxy server intact at state 508. Otherwise, at state 510, the TLD LSP computes the IP address, 24.13.1.56 that corresponds to TLD name “DOE”. The TLD LSP at state 512 uses this IP address to contact the “DOE” TLD name server to resolve “JOHN.DOE”, resulting in another IP address that the TLD LSP uses at state 514 to contact “JOHN.DOE”'s SLD name server to resolve “WWW”. At state 516, if the resolution of the address “www.john.doe” was successful, the TLD LSP at state 520 replaces the domain name in the Internet Address with the IP address resulting from the resolution and transmits the changed request to the proxy server. If the domain name was not resolved successfully, then the TLD LSP transmits the request to the proxy server intact at state 508.

By intercepting the requests being sent to a proxy server, the TLD LSP captures those Internet Addresses that are not sent to NSPs for resolution. The TLD LSP ignores those that are standard ICANN TLDs in order to let the existing DNS server used by the proxy perform the name resolution.

As described above, various embodiments of the present invention advantageously provide systems and methods for registering and resolving Internet addresses containing arbitrary non-ICANN TLDs. Further, systems and methods for translating Internet addresses containing non-ICANN TLDs using a proxy server are provided.

It will be appreciated that, although specific embodiments of the invention have been described herein for purposes of illustration, various modifications may be made without departing from the spirit and scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer according to the method of the invention and/or to structure its components in accordance with the system of the invention. Further, each step of the method may be executed on any general computer, such as an IBM mainframe, PC or the like and pursuant to one or more, or a part of one or more, program elements, modules or objects generated from any programming language, such as C, C++, Java or the like. And still further, each said step, or a file or object or the like implementing each said step, may be executed by special purpose hardware or a circuit module designed for that purpose. Accordingly, the scope of protection of this invention is limited only by the following claims and their equivalents.

What is claimed is:

1. A method for using a top-level domain (TLD) name in an Internet address, the method comprising the following steps:
receiving a TLD name at a registration server;
translating said TLD name to a first IP address using a domain name translation software executing on said registration server;
binding said first IP address to a network interface on a name server computer (TLD NS);
receiving from a first computer program at a second computer program data corresponding to an Internet address including said TLD name;
translating said TLD name to said first IP address using said domain name translation software executed by said second computer program;
connecting to said TLD NS at said first IP address; and
querying said TLD NS for a second IP address corresponding to the second label in said Internet address.

2. A method for registering a top-level domain (TLD) name, the method comprising the following steps:
receiving a TLD name at a registration server;
translating said TLD name to a first IP address using a domain name translation software executing on said registration server; and
binding said first IP address to a network interface on a name server computer.

3. A method for resolving an Internet address having a non-ICANN TLD name, the method comprising the following steps:
receiving from a first computer program at a second computer program data corresponding to an Internet address including a non-ICANN TLD name;
translating said TLD name to a first IP address using a domain name translation software executed by said second computer program;
connecting to a first name server at said first IP address; and
querying said first name server for a second IP address corresponding to the second label in said Internet address.

4. A method as claimed in claim 3, further comprising the following steps:
receiving from said first name server said second IP address of a second name server; and
querying iteratively said second name server and subsequent name servers of domains in the Internet address.

5. A method as claimed in claim 2, wherein said IP address belongs to a set of IP addresses having a predetermined subnet prefix.

6. A method as claimed in claim 2, wherein said TLD name is an internationalized label as defined in RFC 3490.

7. A method as claimed in claim 2, wherein said TLD name is a non-ICANN TLD name.

8. A method as claimed in claim 2, wherein said TLD NS is selected from a group of server computers prior to binding said IP address to said TLD NS.

9. A method as claimed in claim 2, wherein said registration server searches a TLD database prior to binding said IP address to said TLD NS.

10. A method as claimed in claim 2, wherein said registration server stores said TLD name into a TLD database after binding said IP address to said TLD NS.

11. A method as claimed in claim 3, wherein said first computer program executes on a user's client system and said second computer program executes on a user's Internet Service Provider Domain Name Server.

12. A method as claimed in claim 3, wherein said first computer program and said second computer program execute on a user's client system.

13. A method as claimed in claim 3, further comprising the following steps:
receiving a second IP address from said first name server; and
querying a second name server at said second IP address for a third IP address corresponding to the second label in said Internet address.

14. A method as claimed in claim 11, wherein said client system is one of a personal computer, a handheld computer, a digital personal assistant, a wireless telephone, and a computing device having means of communication in a network environment.

15. A system for registering non-ICANN TLD names, the system comprising: a first instruction configured to translate a first non-ICANN TLD name into a first IP address; and a second instruction configured to bind the first IP address to a network interface in a server computer.

16. A system for resolving an Internet address having a non-ICANN TLD name, the system comprising: a first instruction configured to translate a first non-ICANN TLD name into a first IP address; and a second instruction configured to query name servers iteratively starting with a name server at the first IP address.

17. A system as claimed in claim 16, further comprising a name server software used to resolve addresses having ICANN TLD names.

18. A system as claimed in claim 16, further comprising one of a Name Service Provider and a Layered Service Provider.

19. A system for as claimed in claim 18, wherein the Layered Service Provider further comprises: a third instruction configured to detect the first non-ICANN TLD name in the Internet address in one of an HTTP and a proxy application level protocol; a fourth instruction configured to obtain a second IP address corresponding to the Internet address; and a fifth instruction configured to replace the Internet address contained in an appropriate protocol header with the second IP address.

20. A program storage device readable by a machine, tangibly embodying a program of instructions executable by a machine as claimed in claim 16.
